(19) United States
(12) Patent Application Publication
(10) Pub. No.: US 2016/0073070 A1
(43) Pub. Date: Mar. 10, 2016

(54) PROJECTION SYSTEM WITH IMAGE BLENDING LENSES

(71) Applicant: Robert M. Spearman, Bremerton, WA (US)

(72) Inventor: Robert M. Spearman, Bremerton, WA (US)

(21) Appl. No.: 14/847,937

(22) Filed: Sep. 8, 2015

Related U.S. Application Data
(60) Provisional application No. 62/048,137, filed on Sep. 9, 2014.

(51) Int. Cl. H04N 9/31; G02B 5/20; G03B 21/56; G02B 13/16

(52) U.S. Cl. CPC H04N 9/3138; G02B 13/16; G02B 5/205; G03B 21/56; H04N 9/3185

(57) ABSTRACT

An image projection system having a screen, and a plurality of image projectors, each image projector configured to project an image onto the screen, each image projector having a projection lens assembly that includes a diverging lens element having a front side structured to face the screen and an opposing back side, and an attenuating mask located either on the diverging lens element or immediately adjacent the diverging lens element.

### BACKGROUND OF THE INVENTION

1. Field of the Invention

The present disclosure is directed to optical projection systems and methods and, more particularly, to a high resolution projection system for immersive simulators such as planetarium domes.

2. Description of the Related Art

In the ongoing development of digital projection systems, the goals of increased brightness, increased resolution, improved contrast, larger color gamut, reduced size, and reduced cost have been forefront in the minds of projection system designers. However, as any one of these dimensions has been improved, it has often been at the expense of diminished performance in another.

Contrast is important because it increases the difference between dark and bright areas for a more natural image. No digital projector has a perfect (no light output) black level. The black level is very important to planetarians, who want the most realistic dark sky possible in their planetarium domes. Some projectors are claimed to achieve contrast ratios of 2,500,000:1, but are unaffordable for most applications. High contrast CRT projectors are dated technology and too dim.

Higher brightness projectors are desired in situations with a large screen or bright ambient lighting. Planetarium domes have an extremely large screen area for a given seating capacity.

Higher resolution projection is desirable when detailed information needs to be displayed, such as for purposes of scientific visualization. Even the current standard “4k” resolution for digital cinema allows those with average eyesight to occasionally be distracted by the pixilation of the image on a flat screen. The situation is far worse in a planetarium, where the magnification is so much greater.

For flat screen situations, it is often possible to tile multiple projectors to achieve a higher resolution and brightness than a more expensive single projector, if one is even available. In such an instance each adjacent projected image is partially overlapped on the screen. Then computer software, firmware or hardware, or a combination of the foregoing, is typically configured to warp and edge blend the video frames before sending to each projector. Warping is used to align the image content in the overlapped images to produce a single combined image. This alignment is otherwise physically difficult or impossible due to keystone distortion, the use of non-planar screens, and other factors. The edge blending algorithm transitions the brightness from one projected image to the next gradually in order to hide the transitions between them. See Surati and Knight (U.S. Pat. No. 6,456,339) for prior art on this topic, including using a camera to automate the blending and warping.

One important aspect of this technique is black level masking. In areas where multiple projected images overlap, the non-zero black level is multiplied. When a dark image is projected in an environment with low ambient lighting the overlap areas are often jarringly apparent. In these situations the darkest colors need to be increased in intensity in the areas outside the overlap area so that black will match the maximum brightness of black in the overlap area. This hides the overlap area. While necessary, this unfortunately reduces the overall contrast of the combined image.

In planetarium domes, which are typically used for astronomical simulations and scientific visualizations for educational purposes, bright, high resolution projection systems are very desirable because the dome screen covers a large area and small pinpoint details like stars need to be projected in a realistic manner. The current highest resolution digital planetariums are “8k”, meaning that a diameter of the projection across the dome is about eight thousand pixels, providing about 50 megapixels in total on screen.

The highest resolution planetarium projection systems use arrays of projectors around the perimeter of the dome with extensive computing power to render the desired content and then warp and edge blend image content before sending it to the appropriate projector. The techniques are similar to a flat screen situation, but the overlapping areas are typically more complex and more numerous. In addition, a substantial amount of brightness and resolution is lost due to the large overlap between projectors. Often five or more color matched projectors are used. A fisheye view of a dome screen 100 covered with images 102, 104, 106, 108, 110, and 112 from six projectors (not shown) is illustrated in FIG. 1. Note the overlap areas such as 114, 116, and especially where four projected images overlap 118. Unless costly projectors with extremely high contrast are used, black level quadrupling is an issue since there is typically no ambient light in a planetarium. Rather than bring up the overall black level and lose contrast, some sort of physical masking is usually employed at each projector.

Another fairly common configuration in planetariums is to use two projectors with fisheye lenses designed to cover just over half of the dome. These are either placed at the center projecting outwards, or on opposite sides and projecting across the dome. In either case color matching and warping is used. Again, to preserve contrast and keep black levels low, physical masking is employed.

Physical masking attenuates the projection edges so that seams where two projectors meet will be less obvious in both bright and dark scenes. If well executed, the non-zero black level does not visibly change in the seams and is not distracting. Prior approaches for physical projection masking have taken three forms: external masks, rear masks, and internal masks.

When an external mask is used, an opaque shape is placed between a projection lens and the screen. Typically the mask is placed near the lens, producing a soft edge on screen. See, for example, U.S. Pat. No. 7,278,746. Seam quality is imperfect because the projection intensity curves in the blend region are determined by some combination of vignetting and diffraction, which is not ideal. Color fringing can be particularly problematic with wide angle lenses.

When rear masks are used, an opaque shape is placed between the image source and the first element of the projection lens. As this is outside an image plane, the mask can produce vignetting which can be adjusted with the shape and positioning of the mask. The ideal position would be just above the plane of the image source(s) but this is almost always highly impractical.

When an internal mask is used, typically a precisely cut opaque metal mask is positioned near the image plane of a relay type projection lens. If the mask is slightly offset from the image plane, the edges are softened, and can be used as a blend region on the screen. This tends to produce better results than external masking, but requires a larger and more expensive lens design. The mask must be precisely manufactured and aligned, but is deep within the lens. U.S. Pat. No. 6,592,225 describes a large relay adapter that fits between a standard projector and projection lens to enable use of an internal mask within the relay assembly. In some systems, the mask must be customized for different dome sizes due to parallax, adding complexity and overhead.

A neutral density (ND) gradient filter can also be used as an internal mask near the image plane in a relay type projection lens. This can provide a larger, gradual, and more controlled blend region. This has been used with a two projector dome projection system.

It is difficult to get good blends between more than two projectors at a time with either external masks or an internal opaque mask since the blend area will be a combination of multiple soft projection edges. In these cases the blend regions are usually somewhat too bright and software image attenuation based on camera data is necessary to fully hide the seams in bright scenes. If these seams are apparent in dark scenes, black levels would likewise need to be increased, hurting contrast. An internal neutral density mask could produce better results, but poses a fabrication challenge due to the small image size in the relay lens.

Both internal approaches require tight manufacturing tolerances, and exacting alignment of the masks deep within the projection lens. Usually alignment must be done in the field. Relay lenses are significantly larger, heavier, and more expensive than non-relay lenses.

Three other possible solutions for combining multiple image sources on a dome involve combining the images before projection: Balu (U.S. Pat. No. 6,871,961), Kasahara (U.S. Pat. No. 7,293,881), and Nishigaki (U.S. Pat. No. 7,748,852). However, none of these methods appears to have been commercialized.

### BRIEF SUMMARY OF THE INVENTION

The implementations of the present disclosure are directed to projection systems and means of combining multiple image sources into a single projection.

In accordance with one aspect of the present disclosure, an image projection system is provided that includes a projection screen, a plurality of image projectors, each image projector configured to project an image onto the projection screen, and a projection lens assembly associated with each image projector, each projection lens assembly including a diverging lens element and an attenuating mask located on the diverging lens element or immediately adjacent the diverging lens element.

In accordance with another aspect of the present disclosure, an image projection system is provided that includes a screen, and a plurality of image projectors, each image projector configured to project an image onto the screen, each projector including a projection lens assembly having a diverging lens element and a patterned attenuating light transmission filter not located at or adjacent to an image plane or aperture of the lens assembly.

In accordance with a further aspect of the present disclosure, an image projection system is provided that includes a plurality of image sources, each image source configured to project at least a portion of a composite image onto at least a portion of a viewing surface, each image source having a lens assembly that includes a diverging lens element having a front side structured to face in the direction of the viewing surface and an opposing back side, and an attenuating mask located either on the diverging lens element or immediately adjacent the diverging lens element.

In accordance with still yet another aspect of the present disclosure, a device is provided that includes a diverging lens, an envelope capable of holding the diverging lens, and an attenuating mask mountable to the diverging lens or the envelope and positioned adjacent the diverging lens, the mask comprising a body having opposing first and second surfaces configured to allow the passage of light and a patterned neutral density coating on one of the first and second surfaces of the transparent body. Ideally, the attenuating mask is positioned adjacent the back side of the diverging lens, and the attenuating mask body includes an opaque portion capable of blocking light passing through the lens.

In accordance with another aspect of the present disclosure, a system is provided that includes a first diverging lens, an attenuating mask formed on the first diverging lens, the first attenuating mask comprising a coating capable of blocking light passing through the first diverging lens to form a first image portion, a second diverging lens, and a second attenuating mask formed on the second diverging lens, the second attenuating mask comprising a coating capable of blocking light passing through the second diverging lens to form a second image portion, the first and second diverging lenses cooperating to form a composite image of the first and second image portions that is viewable on a viewing surface.

### BRIEF DESCRIPTION OF THE SEVERAL VIEWS OF THE DRAWING(S)

The foregoing and other features and advantages of the present disclosure will be more readily appreciated as the same become better understood from the following detailed description when taken in conjunction with the accompanying drawings, wherein:

FIG. 1 illustrates a known dome screen divided among six separate projectors;

FIG. 2 illustrates a dome projection system formed in accordance with the present disclosure;

FIG. 3 is a top down view of projectors and lenses in the system shown in FIG. 2;

FIG. 4 is an enlarged view of an attenuating mask pattern at each lens in the system shown in FIG. 2;

FIG. 5 is a top down orthogonal view of a dome screen showing a projection overlap area in the system shown in FIG. 2;

FIG. 6 illustrates lines of equal optical density in the attenuating mask pattern shown in FIG. 4;

FIG. 7 is a top down view of projectors and lenses in another dome projection system formed in accordance with the present disclosure;

FIG. 8 is an enlarged view of an attenuating mask pattern at each lens in the system shown in FIG. 7;

FIG. 9 is a top down orthogonal view of the dome screen showing the projection overlap area in the system shown in FIG. 7;

FIG. 10 illustrates a topmost (exit side) portion of a projection lens assembly formed in accordance with the present disclosure;

FIG. 11 illustrates a removable attenuating mask formed in accordance with another aspect of the present disclosure; and

FIG. 12 illustrates an adjustable attenuating mask formed in accordance with a further aspect of the present disclosure.

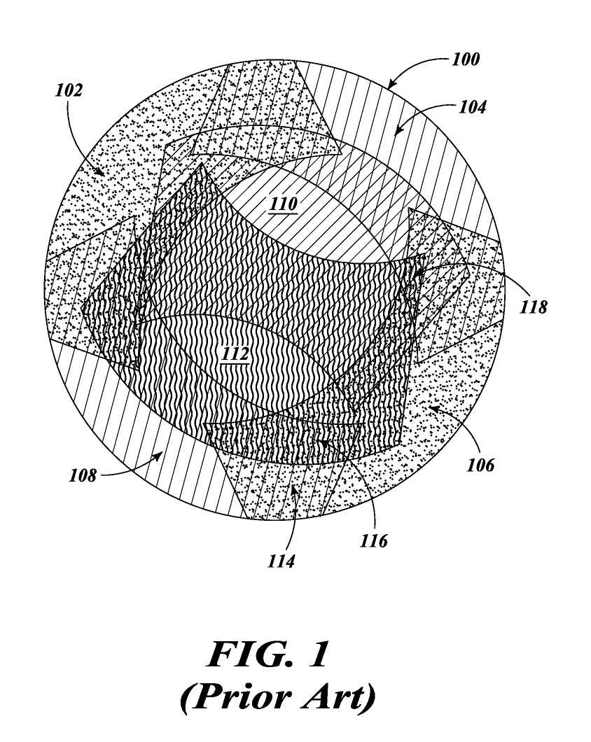

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures or components, or both, associated with projection systems, including but not limited to power supplies, controllers, and related software have not been shown or described in order to avoid unnecessarily obscuring descriptions of the implementations.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one implementation” or “an implementation” means that a particular feature, structure, or characteristic described in connection with the implementation is included in at least one implementation. Thus, the appearance of the phrases “in one implementation” or “in an implementation” in various places throughout the specification are not necessarily all referring to the same implementation. Furthermore, the particular features, structures, or characteristics may be combined in any suitable manner in one or more implementations.

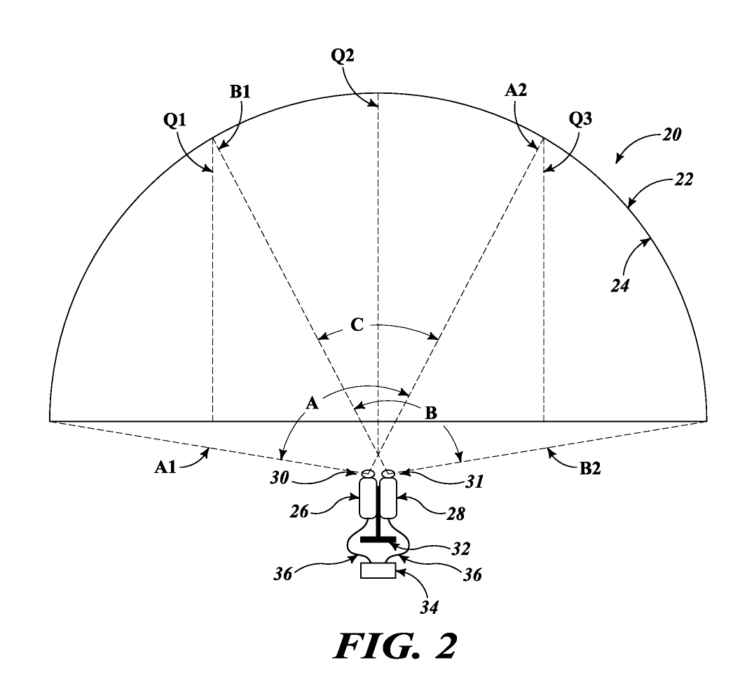

Referring to FIG. 2, shown therein is a projection system 20 formed in accordance with the present disclosure. As shown, the system 20 includes a dome screen 22 having a concave screen surface 24 configured to receive one or more images for visual perception by a viewer located under the dome screen 22. This screen is of a known type that is commercially available and will not be described in more detail herein. The system 20 also includes a pair of first and second projectors 26, 28 that are structured to project one image (A, B) each onto the screen surface 24 through a respective lens assembly 30, 31. These projectors 26, 28 are also readily commercially available and will not be described in detail herein.

Included in the projection system 20 is a frame 32 structured to support the first and second projectors 26, 28 in a side-by-side relationship as shown. The frame 32 permits adjustability in the positioning of the first and second projectors 26, 28, which in turn permits adjustment in the position of the respective images (A, B) on the screen surface 24. Commercially available projectors also have lens offset adjustment features to aid alignment. It is considered within the level of one of ordinary skill in this technology to construct such a frame or obtain a commercially available frame for this purpose and thus the frame 32 is not described in greater detail herein.

Each of the first and second projectors 26, 28 is capable of receiving an image signal from an image generation system on a computer 34 via a direct wired connection, such as cables 36. It is to be understood that other means of conveying the image signals may also be used, including wireless transmission from the computer 34. These components and the software used to control the computer 34 are not pertinent to the present disclosure and therefore are not described in greater detail. One of ordinary skill in this technology would be able to obtain the computer 34, cables 36, and desired software from readily available commercial sources.

With respect to the images A, B formed by the first and second projectors 26, 28 on the screen surface 24, it can be seen in FIG. 2 that image A is shown by the arc A and bounded by dashed lines A1 and A2 at a plane through the center of the dome. In this side view of the dome screen, image A covers the entire screen surface 24 left of dashed line Q3. Similarly, image B is shown with the arc B that is bounded by dashed lines B1 and B2 at a central plane, and it also covers more than half of the visible screen surface 24, everything to the right of dashed line Q1. It is to be understood that the coverage of the screen surface 24 can vary by application and the foregoing is illustrative of a representative implementation of the present disclosure. It will also be appreciated that the two images A, B have an overlap area C, bounded on the left by dashed line Q1 and on the right by dashed line Q3 in FIG. 2. These two projected images A, B combine together to form a single combined image over the entire viewing surface of the screen surface 24 due to the attenuating masks employed at each lens. The dashed line Q2 at the center of the screen surface 24 represents the center of the overlap area with equal contribution from images A, B of the respective first and second projectors 26, 28.

While video projectors and a computer are shown, it will be recognized that the foregoing system can be implemented in analog form (without the computer and digital type projectors), although this would be much less flexible than the present disclosed system 20.

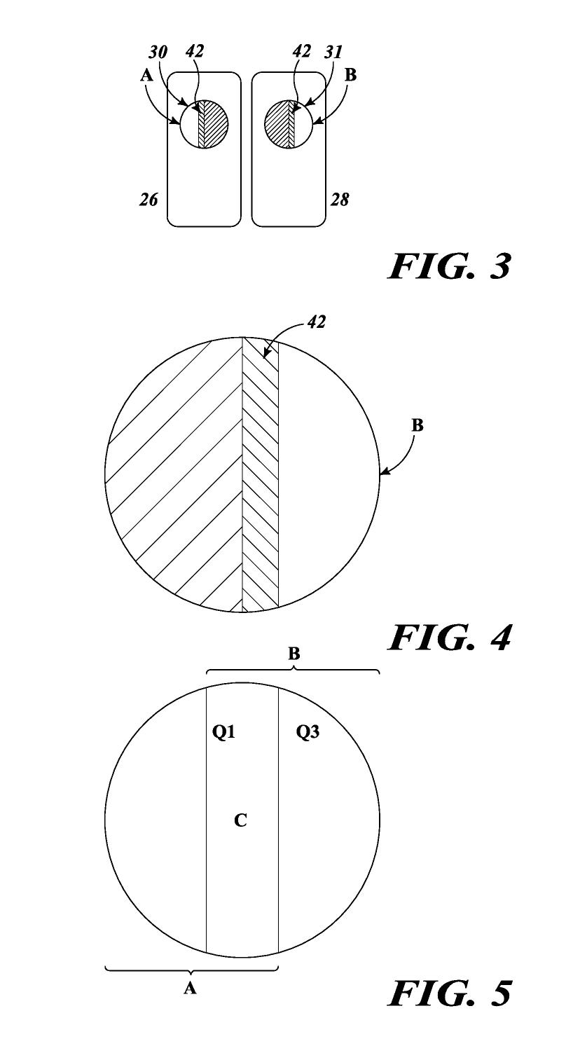

FIG. 3 illustrates a top down view showing the lenses 30, 31 that respectively project the individual images A, B generated by the first and second projectors 26, 28. These are preferably fisheye projection lenses that are each designed to project their respect image over more than half of the dome screen surface 24 as describe above. Because these lenses are known in the art and readily commercially available, they will not be described in detail herein.

An attenuating mask pattern 42 is shown at each lens. The attenuating mask pattern 42 attenuates each of the projected images A, B so as to enable the simultaneously projected images A, B to combine into one image on the screen surface. In a preferred implementation, the same mask pattern 42 is used at both lenses 30, 31, but with opposing orientations.

FIG. 4 is an enlarged view of the attenuating mask pattern 42 at lens 31, which projects image B. As stated above, image A has an opposing orientation to image B shown in FIG. 4. Thus, each projected image A, B has an attenuated portion or transition area that overlaps with a transition area in the other adjacent image to form an overlap area C.

FIG. 5 is a top down orthogonal view of the dome screen 24 showing the overlap area C in the combined projected images A, B.

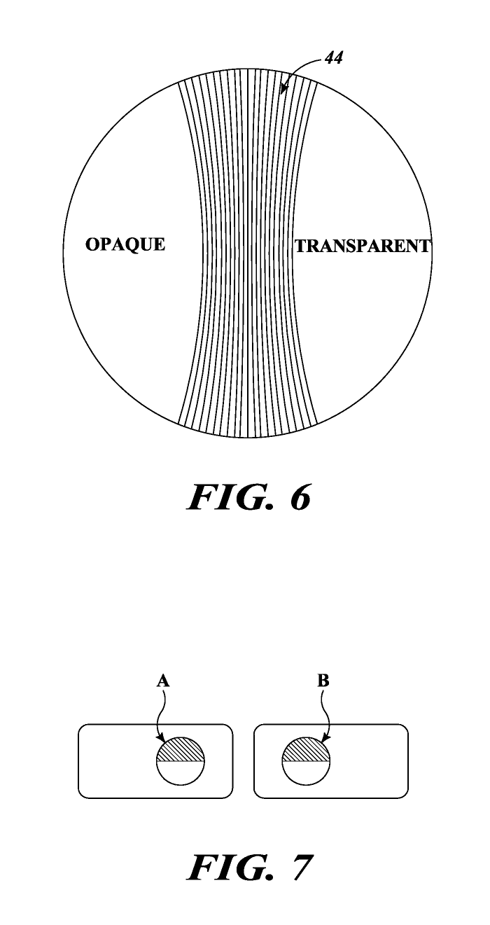

FIG. 6 shows lines 44 of equal optical density in the attenuating mask pattern 42 used in the system 20 at both lenses. Mask and pattern details are discussed below.

The large transition area for each projected image A, B in this implementation means that projector alignment is somewhat forgiving due to the gradual changes at any point on the viewing screen. Another advantage is that any color or brightness differences between the two projectors 26, 28 will be less apparent due to the relatively large transition area for each projected image A, B.

This makes system maintenance easier and less costly. It could also enable the use of brighter or lower cost projectors that cannot be as accurately color matched. Because the gradient pattern generally changes intensity only gradually along a radial line in the lens assembly, there is little apparent color fringing.

To avoid creating new attenuation patterns for every possible dome size, the system 20 should keep the relative geometries of the lenses and dome screen in the same proportions from one dome size to the next. This removes parallax and keeps optimal alignment at the blend area. If the lens-to-lens distance was 20 cm in a 5 meter diameter dome, then this distance should be twice as large, 40 cm, in a 10 meter diameter dome.

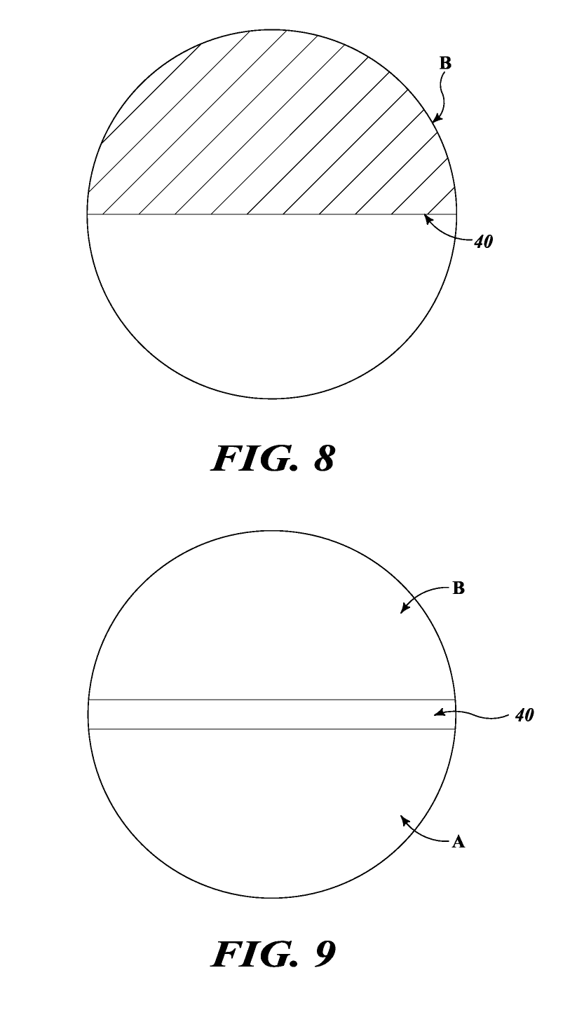

In a second implementation, two projectors are both aligned along a central axis of the dome, as shown in FIG. 7. FIG. 8 shows an enlargement of the attenuating mask pattern used with the two projectors. FIG. 9 shows a top down orthogonal view of the dome showing the small overlap area between the two projected images. While the transition area is much smaller, color fringing is minimal because the gradient pattern intensity changes very little along a radial line. The most extreme radial density changes are near the center of the lens, where lateral color is negligible in a good lens. Note that the projector geometry in this implementation does not require the smaller blend region; this was selected simply for illustrative purposes.

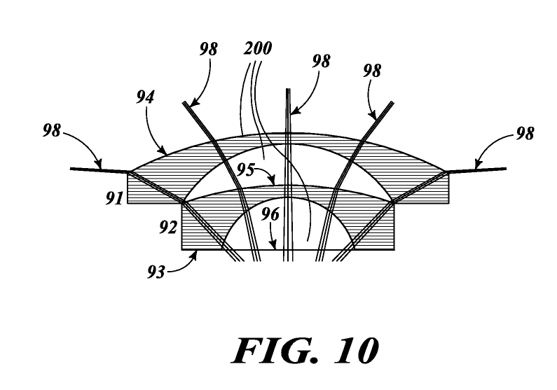

Referring next to FIG. 10, shown therein is a simplified drawing of the topmost portion of a fisheye projection lens assembly 30, 31 having first and second diverging lens elements 91, 92. An optional plate 93 is located on a bottom surface or immediately adjacent a bottom surface of the second diverging lens element 92. The optional plate 93 and lens elements 91, 92, are understood by one of ordinary skill in this technology and will not be described in detail herein. Also shown in FIG. 10 are image light bundles 98 projecting through the lens assembly 30, 31. The light bundles 98 project onto a viewing screen after exiting lens element 91.

In accordance with one aspect of the present disclosure, an attenuating mask pattern is implemented as an ND filter coating 200 applied to a respective surface 94, 95 of one of the diverging lens elements 91, 92 as shown in

FIG. 10. The ND filter coating 200 could alternately be applied to a surface 96 of a planar element, such as the optional plate 93. The ND filter coating 200 is preferably a vacuum deposited light absorptive coating such as black chrome. The coating 200 is ideally continuously varying. The deposition of variable optical density coatings is known to those having ordinary skill in the art, but the patterns, placement, and use described herein are novel.

The projection system 20 uses the ND filter coating 200 to attenuate the projection from each lens 30, 31 so that the two projected images A, B blend together seamlessly with substantially equal perceived intensity across the screen surface 24. The ND coatings used to attenuate the projected images A and B are aligned opposite to each other in the projection system 20 so that at any one point on screen surface 24 the maximum illuminance contribution from both projectors 26, 28 is equal to the maximum illuminance at any point in the combined image on screen. This produces a uniform combined image. For example, when one point on the screen 24 receives 75% of the intensity from one projector 26 the other projector 28 will be providing 25% of its intensity at the same point. The percentage split in projector contributions are fixed for any given point on the screen no matter what the currently displayed source image intensity is for that point, whether it happens to be full white or a darker color.

It should be noted that screen illuminance is often not perfectly uniform in most real world projection applications, often varying by 20% or more between the center and edges of a projected image. Usually the human eye is fairly forgiving. If the non-uniformity of a projector and lens combination is quantified, it can be corrected for in the design of the attenuating masks.

However, if maximum illuminance is of greater importance than perfect uniformity, the final combined image may be measurably non-uniform. In this case the attenuating masks can be selected to keep the transition between images A, B gradual in all areas so as to hide the transition area.

Software warping based on camera data can be used to warp the image content sent to each projector 26, 28 so that the image content of the combined image formed of images A, B is aligned on screen. Alternately, alignment can be accomplished with adjustment of physical lens and projector alignment or through manually configured software alignment features. No software-based edge blending, attenuation, or black level masking is required. Contrast is preserved and projector and lens alignment are straightforward.

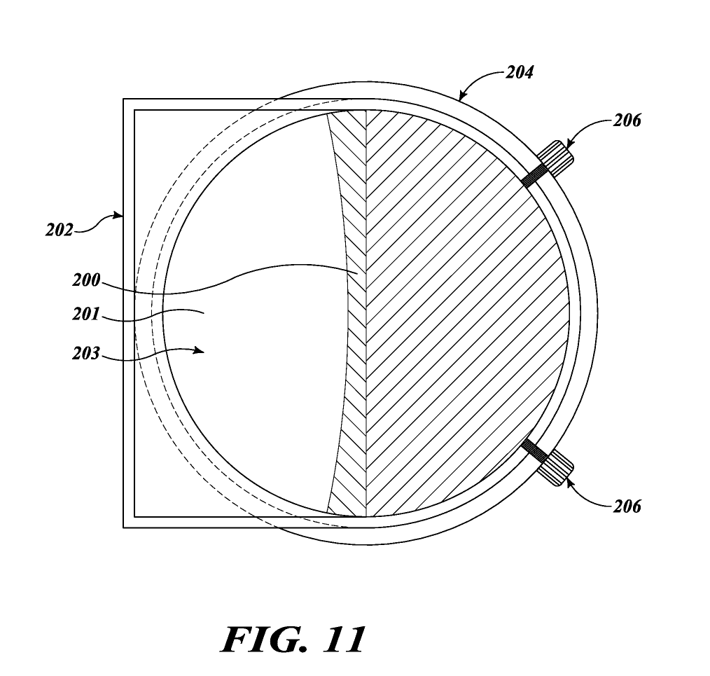

In another implementation shown in FIG. 11, a patterned ND attenuating coating 200 is coated on an optical window 201 to form the ND attenuating filter 203. A tray 202 is built into or removably mounted on a lens envelope 204 in the lens assembly 30, 31. Screws 206 are provided to secure the tray 202 to the lens envelope 204. The tray is positioned so that the optical window 201 (93 in FIG. 10) is positioned just below the second lens element (92 in FIG. 10).

Because this region is closer to the aperture of the lens assembly, more vignetting will occur than at the lens surfaces 94, 95 in FIG. 10. The vignetting reduces precise control over attenuation at any single point on screen. However, this implementation allows custom attenuating masks to be more easily created because it is easier to coat planar surfaces. This also allows the filter to be switchable in the field. The positioning of the filter can be implemented with adjustability, which will enable refinement in the projected image.

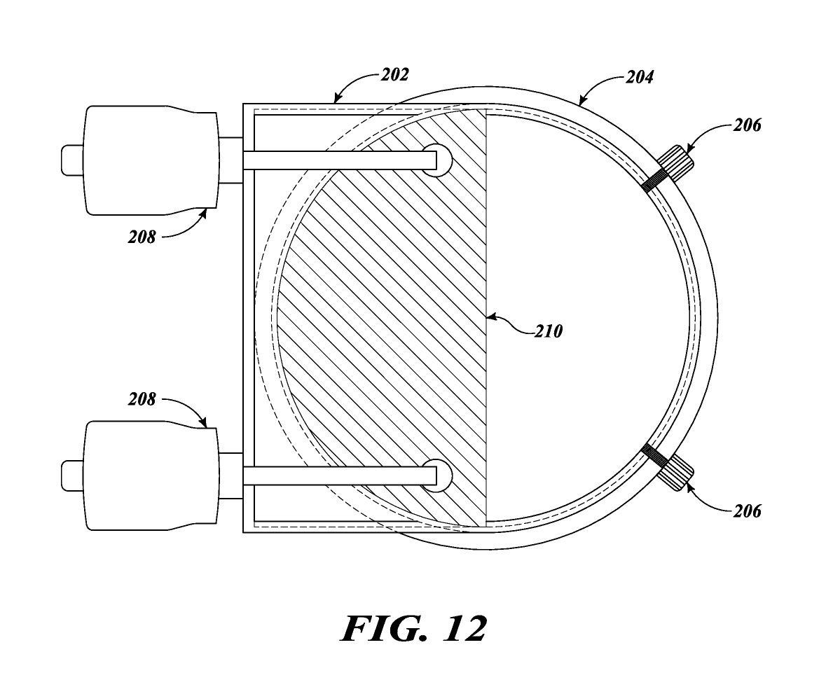

In another similar implementation shown in FIG. 12, an opaque mask 210 is placed below a diverging lens element 92 in FIG. 10. This mask 210 causes some vignetting that can produce softened edges on screen, which may be suitable for some situations. This avoids the expense of producing a patterned ND coating or a relay lens, but comes at the expense of less control over the blend area. In FIG. 12, the tray 202 includes micrometer heads 208 adapted to adjust the position of the attenuating mask, including tilt adjustment.

It is readily apparent that these concepts can be applied to design other implementations, such a dual cove mounted projector system. These techniques could also be applied to systems of more than two projectors, to systems with different screen geometries, or even rear-projection screens.

The attenuating mask pattern for a projection system is designed through the following method, which is most easily accomplished through a computer software program. First the screen is divided up into regions based on the projectors and lenses selected. Each screen region is assigned to a projector, and projector/lens geometries are set so there is sufficient overlap for the desired blend regions between adjacent screen regions. The coordinates of these blend regions are defined and stored along with which projectors cover which regions of these blend regions.

Next, one projection lens is selected and the surface of the element to be coated is divided into a Cartesian grid centered on the optical axis of that element in the lens. Stepping through the x and y coordinates of the grid, a representative primary light ray is traced from the image source up through the x, y coordinate on that element's surface and on through the remaining elements of the lens to its final intersection with the screen using the optical and mechanical design details of the lens and the geometry and placement of the screen and projection lens.

If the screen intersection point is not within a blend region on screen then there is no attenuation needed and this will be a transparent area of the mask pattern. If the point is within a blend region involving this projector, then the attenuation needs to be calculated based on the position of the point within the blend geometry. For example, if the point was half way between the two edges of a two projector blend region it would have a desired attenuation of ½.

When a point is in a region with multiple overlapping projectors, a similar calculation is performed, but accounting for all contributing projectors. For example, a point equally spaced from the three edges of three-projector overlap geometry would have an attenuation factor of ⅔ for any one projector, meaning that only ⅓ of the total possible illuminance from a lens for that point should reach the screen. This assumes equal intensity from each projector and consistent intensity across a single projected image. If these are not equal, these can be accounted for in the calculation.

When the process is complete for this lens element, a digital rendering of the attenuating mask pattern optical density is created for the surface of the element. This is repeated for all projection lenses in the projection system. These high resolution renderings can then be converted into formats needed for the ND coating deposition process using standard data/image processing techniques.

This disclosure offers an improved method for blending multiple projectors into a single combined onscreen image, offering better control over the blend regions at lower cost. A more gradual transition can reduce the importance of precise projector alignment and color matching and the extent and expense of projector maintenance. This opens up the possibility of using brighter or lower cost projectors that are harder to color match. Smaller and lower cost lenses can be used compared to masking techniques requiring relay lenses. Black levels and contrast are preserved. The complexity and expense of software based image blending or attenuation masking can be avoided.

By using the reasoning in this disclosure, it is evident that many other variations are possible.

From the foregoing it will be appreciated that, although specific implementations of the invention have been described herein for purposes of illustration, various modifications may be made without deviating from the spirit and scope of the invention. For example, while the present disclosure has been described in the context of domes it is to be understood that the disclosed implementations can utilize any display surface. Moreover, the disclosed implementations can be used with a variety of projection systems and projectors, including without limitation digital micro-mirror devices, liquid crystal, and liquid crystal on silicon, direct drive image light amplifier, cathode ray tube, and laser. Accordingly, the disclosure is not limited except as by the appended claims that follow and the equivalents thereof.

1. An image projection system, comprising:
a screen; and
a plurality of image projectors, each image projector configured to project an image onto the screen, each image projector having a projection lens assembly that includes a diverging lens element having a front side structured to face in the direction of the screen and an opposing back side, and an attenuating mask located either on the diverging lens element or immediately adjacent the diverging lens element.

2. The image projection system of claim 1 wherein the attenuating mask comprises a coating deposited on the diverging lens element.

3. The image projection system of claim 1, comprising a non-diverging lens element located adjacent the diverging lens element, and wherein the attenuating mask comprises a coating deposited on the non-diverging lens element.

4. The image projection system of claim 3 wherein the attenuating mask element is removably engaged with the projection lens assembly and is capable of being removed without requiring disassembly of the projection lens assembly.

5. The image projection system of claim 3 wherein the attenuating mask element is engaged with the projection lens assembly and is capable of being adjusted in alignment relative to the optical axis of the projection lens assembly without requiring disassembly of the projection lens assembly.

6. The image projection system of claim 1, further comprising a computer system capable of controlling each image projector and performing warping of image content sent to each image projector to facilitate alignment of the image content in a composite image formed on the screen by the plurality of image projectors.

7. An image projection system, comprising:
a screen; and
a plurality of image projectors, each image projector configured to project an image onto the screen, each projector including a projection lens assembly having a diverging lens element and a patterned attenuating light transmission filter not located at or adjacent to an image plane or aperture of the lens assembly.

8. An image projection system, comprising:
a plurality of image sources, each image source configured to project at least a portion of a composite image onto at least a portion of a viewing surface, each image source having a lens assembly that includes a diverging lens element having a front side structured to face in the direction of the viewing surface and an opposing back side, and an attenuating mask located either on the diverging lens element or immediately adjacent the diverging lens element.

9. The system of claim 8 wherein the attenuating mask comprises a coating deposited on the diverging lens element.

10. The system of claim 8 wherein the attenuating mask comprises an opaque mask located at the back side of the diverging lens element.

11. The system of claim 8, further comprising a viewing surface and a computer system capable of controlling each image source and performing warping of image content sent to each image source to facilitate alignment of the image content in the composite image formed on the viewing surface by the plurality of image sources.

12. A device, comprising:
a diverging lens;
an envelope capable of holding the diverging lens; and
an attenuating mask mountable to the diverging lens or the envelope and positioned adjacent the diverging lens, the mask comprising a body having opposing first and second surfaces configured to allow the passage of light and a patterned neutral density coating on one of the first and second surfaces of the transparent body.

13. The device of claim 12, wherein the attenuating mask is positioned adjacent the back side of the diverging lens, and the attenuating mask body includes an opaque portion capable of blocking light passing through the lens.

14. A projection system, comprising:
a first diverging lens;
an attenuating mask formed on the first diverging lens, the first attenuating mask comprising a coating capable of blocking light passing through the first diverging lens to form a first image portion;
a second diverging lens; and
a second attenuating mask formed on the second diverging lens, the second attenuating mask comprising a coating capable of blocking light passing through the second diverging lens to form a second image portion, the first and second diverging lenses cooperating to form a composite image of the first and second image portions that is viewable on a viewing surface.
